(19) United States
(12) Patent Application Publication
(10) Pub. No.: US 2011/0268978 A1
(43) Pub. Date: Nov. 3, 2011

(54) POLARIZER PROTECTION OPTICAL FILM, POLARIZING PLATE, AND IMAGE DISPLAY DEVICE

(76) Inventors: Kazuaki Watanabe, Tokyo (JP); Takatoshi Yosomiya, Tokyo (JP)

(21) Appl. No.: 13/131,038

(22) PCT Filed: Nov. 25, 2009
(86) PCT No.: PCT/JP2009/069829

§ 371 Date: Jul. 12, 2011

(30) Foreign Application Priority Data
Nov. 25, 2008 (JP) 2008-299371

(51) Int. Cl. B32B 27/06; C08K 5/3475

(52) U.S. Cl. 428/500; 524/91

(57) ABSTRACT

The optical film for protecting a polarizer of the present invention contains a mixture containing a polypropylene resin containing a propylene copolymer, and 2-(2H-benzotriazol-2-yl)-4-(1,1,3,3-tetramethylbutyl)phenol.

An optical film for protecting a polarizer is provided that has an ultraviolet ray absorbing function and is excellent in optical characteristics.

### TECHNICAL FIELD

The present invention relates to an optical member used in an image display apparatus, and more specifically, relates to an optical film for protecting a polarizer that has an ultraviolet ray absorbing function and is excellent in optical characteristics. The present invention also relates to a polarizing plate having the optical film formed on at least one surface of a polarizer, and an image display apparatus having the polarizing plate.

### BACKGROUND ART

A polarizing plate is an optical member that has a function of transmitting only light having a particular vibration direction and shielding other components of light. A polarizing plate has been widely used, for example, in an image display apparatus, such as a liquid crystal display including a liquid crystal cell, an organic electroluminescence display apparatus and a touch sensitive panel. As the polarizing plate, one having such a structure that has an optical film for protecting a polarizer formed on one surface or both surfaces of a polarizer is generally used. As the polarizer in the structure, which has a function of transmitting only light having a particular vibration direction, a uniaxially stretched polyvinyl alcohol (which is hereinafter referred to as “PVA”) film died with iodine or a dichroic dye is often used, and a coating type film is being used in recent years. However, it generally has a small thickness which brings about a problem of small strength.

The optical film for protecting a polarizer formed on a polarizer has such functions as supporting the polarizer to impart practical strength to the entire polarizing plate, and physically protecting the surface of the polarizer, and thus is demanded to have a practical physical strength, be good in transparency (visible light transmittance) and turbidity (haze), and is excellent in optical homogeneity, such as a low birefringence (in-plane phase retardation). As the optical film for protecting a polarizer, in general, a cellulose triacetate film, which is a cellulose based film, has been often used. However, a cellulose based film is insufficient in moisture resistance, and thus has such problems as change in dimension due to water absorption and deterioration of the performance of the polarizer due to permeated water.

As an optical film for protecting a polarizer having moisture resistance, an optical film for protecting a polarizer using a polypropylene resin is proposed (see Patent Documents 1 and 2).

### RELATED ART DOCUMENTS

### Patent Document

[Patent Document 1] JP-A-2008-146023
[Patent Document 2] JP-A-2007-334295

### DISCLOSURE OF THE INVENTION

A polarizer used in a polarizing plate has a problem that the polarizer is liable to be deteriorated with an ultraviolet ray since it is an organic member. Therefore, an optical film for protecting a polarizer formed on the surface of the polarizer is demanded to have an ultraviolet ray absorbing capability to provide a function of protecting the polarizer from an ultraviolet ray. Furthermore, a polypropylene resin generally has a tendency of being deteriorated under a high temperature and direct sunlight.

In the case where a polypropylene resin is used in an optical film for protecting a polarizer, it is necessary to enhance the ultraviolet ray absorbing capability thereof.

As a technique for imparting an ultraviolet ray absorbing capability to a resin film, it has been known to add an ultraviolet ray absorbent thereto. Examples of the ultraviolet ray absorbent that is ordinarily used for the purpose include various kinds of compounds, such as an oxybenzophenone compound, a benzotriazole compound, a salicylate ester compound, a benzophenone compound, a cyanoacrylate compound and a nickel complex salt compound.

In the case where an optical film for protecting a polarizer is produced by mixing an ultraviolet ray absorbent in a polypropylene resin, however, most kinds of ultraviolet absorbents impair the optical capability of the propylene resin, such as high transparency, turbidity and in-plane phase retardation. A high optical capability is demanded in the purposes of the optical film for protecting a polarizer, and therefore, the deterioration in optical capability that is permissible in the other purposes causes a severe problem in the purposes of the optical film for protecting a polarizer. Furthermore, there are such ultraviolet ray absorbents that cannot exert an ultraviolet ray absorbing capability unless a large amount thereof is added, and that impair the processability and the product quality due to the phenomenon that the ultraviolet absorbent added only in a small amount is deposited on the surface of the film upon molding the film (bleed out).

The present invention has been made under the circumstances, and an object thereof is to provide an optical film for protecting a polarizer that has an ultraviolet ray absorbing capability and is excellent in optical characteristics, by finding out an ultraviolet ray absorbent that is suitable for an optical film for protecting a polarizer using a polypropylene resin.

The present invention provides:

(1) an optical film for protecting a polarizer, containing a mixture containing a polypropylene resin containing a propylene copolymer, and 2-(2H-benzotriazol-2-yl)-4-(1,1,3,3-tetramethylbutyl)phenol;

(2) the optical film for protecting a polarizer according to the item (1), wherein a content of 2-(2H-benzotriazol-2-yl)-4-(1,1,3,3-tetramethylbutyl)phenol in the mixture is from 0.08 to 5.5% by mass;

(3) the optical film for protecting a polarizer according to the item (1) or (2), wherein the polypropylene resin has a melt flow rate of 7 g per 10 minutes or more;

(4) a polarizing plate containing a polarizer having formed on at least one surface thereof the optical film for protecting a polarizer according to any one of the items (1) to (3); and

(5) an image display apparatus containing the polarizing plate according to the item (4).

According to the present invention, an optical film for protecting a polarizer is provided that has an ultraviolet ray absorbing capability and is excellent in optical characteristics. This is because the ultraviolet ray absorbent used in the optical film for protecting a polarizer of the present invention, i.e., 2-(2H-benzotriazol-2-yl)-4-(1,1,3,3-tetramethylbutyl)phenol, does not impair the good optical characteristics of the polypropylene resin containing a propylene copolymer, such as transparency, turbidity and in-plane phase retardation. Furthermore, the ultraviolet ray absorbent exerts a good ultraviolet ray absorbing capability and causes no bleed out upon molding the film, with an amount added in a prescribed range. In general, it is considered to be difficult to estimate as to whether or not a certain ultraviolet ray absorbent affects the optical capability and causes bleed out of the ultraviolet ray absorbent.

Furthermore, a polarizing plate and an image display apparatus that have a high capability can be provided by using the optical film for protecting a polarizer.

### BRIEF DESCRIPTION OF THE DRAWINGS

FIG. 1

The figure is a diagram showing a structural example of a polarizing plate of the present invention.

FIG. 2

The figure is a diagram showing a structural example of a liquid crystal display containing a polarizing plate of the present invention.

### DESCRIPTION OF THE SYMBOLS

1: optical film for protecting polarizer
2: polarizer
3: adhesive layer
4: polarizing plate
5: phase retardation film (birefringence film)
6: liquid crystal cell

### BEST MODE FOR CARRYING OUT THE INVENTION

### Optical Film for Protecting Polarizer

The optical film for protecting a polarizer of the present invention is obtained by molding a mixture containing a polypropylene resin containing a propylene copolymer (which may be hereinafter referred simply to as a “polypropylene resin”), and 2-(2H-benzotriazol-2-yl)-4-(1,1,3,3-tetramethylbutyl)phenol (which may be hereinafter referred simply to as a “mixture”).

More specifically, the optical film is produced in such a manner that the polypropylene resin and 2-(2H-benzotriazol-2-yl)-4-(1,1,3,3-tetramethylbutyl)phenol are mixed and melted by heating, and then molded in various molding method, for example, an unstretching T-die extrusion molding method.

The optical film for protecting a polarizer and the production method thereof will be described in detail below.

### Polypropylene Resin Containing Propylene Copolymer

The polypropylene resin constituting the optical film for protecting a polarizer of the present invention contains a propylene copolymer. The propylene copolymer is a copolymer of propylene with one kind or two or more kinds of comonomers. The copolymer may be a random copolymer or a block copolymer, and is preferably a random copolymer from the standpoint of optical characteristics. Examples of the random copolymer include a propylene random copolymer obtained by copolymerizing propylene with at least one of an α-olefin selected from the group consisting of ethylene and α-olefins having from 4 to 20 carbon atoms.

Examples of the α-olefin having from 4 to 20 carbon atoms include 1-butene and 2-methyl-1-propene (all C4); 1-pentene, 2-methyl-1-butene and 3-methyl-1-butene (all C5); 1-hexene, 2-ethyl-1-butene, 2,3-dimethyl-1-butene, 2-methyl-1-pentene, 3-methyl-1-pentene, 4-methyl-1-pentene and 3,3-dimethyl-1-butene (all C6); 1-heptene, 2-methyl-1-hexene, 2,3-dimethyl-1-pentene, 2-ethyl-1-pentene and 2-methyl-3-ethyl-1-butene (all C7); 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyle-1-pentene and 2,3-diethyl-1-butene (all C8); 1-nonene (C9); 1-decene (C10); 1-undecene (C11); 1-dodecene (C12); 1-tridecene (C13); 1-tetradecene (C14); 1-pentadecene (C15); 1-hexadecene (C16); 1-heptadecene (C17); 1-octadecene (C18); and 1-nonadecene (C19).

In the α-olefins, α-olefins having from 4 to 12 carbon atoms are preferred. 1-Butene, 1-pentene, 1-hexene and 1-octene are preferred, and 1-butene and 1-hexene are more preferred, from the standpoint of copolymerizability.

Examples of the propylene random copolymer include a random copolymer of propylene and ethylene, a random copolymer of propylene and an α-olefin, and a random copolymer of propylene, ethylene and an α-olefin. More specifically, examples of the random copolymer of propylene and an α-olefin include a random copolymer of propylene and 1-butene, a random copolymer of propylene and 1-hexene, and a random copolymer of propylene and 1-octent. Examples of the random copolymer of propylene, ethylene and an α-olefin include a random copolymer of propylene, ethylene and 1-butene, a random copolymer of propylene, ethylene and 1-hexene, and a random copolymer of propylene, ethylene and 1-octene.

Among these, a random copolymer of propylene and ethylene, a random copolymer of propylene and 1-butene, a random copolymer of propylene and 1-hexene, a random copolymer of propylene, ethylene and 1-butene, and a random copolymer of propylene, ethylene and 1-hexene are preferred.

The content of the constitutional unit derived from the comonomer in the propylene copolymer is preferably more than 0% by mass and 40% by mass or less, more preferably more than 0% by mass and 20% by mass or less, and further preferably more than 0% by mass and 10% by mass or less from the standpoint of balance between transparency and heat resistance. In the case of a copolymer of two or more kinds of comonomers and propylene, the total content of the constitutional units derived from all the comonomers contained in the copolymer is preferably within the range.

The content of the constitutional unit derived from the comonomer in the copolymer may be obtained by measuring an infrared (IR) spectrum.

The tacticity of the propylene copolymer may be any one of isotactic, syndiotactic and atactic, and the tacticity is preferably syndiotactic or atactic from the standpoint of heat resistance.

Examples of the production method of the propylene copolymer include a method of copolymerizing with at least one monomer selected from the group consisting of ethylene and α-olefins having from 4 to 20 carbon atoms, by using a known polymerization catalyst.

Examples of the known polymerization catalyst used in production of the propylene copolymer component include a Ziegler-Natta catalyst.

Examples of the Ziegler-Natta catalyst include a Ti—Mg catalyst containing a solid catalyst component containing magnesium, titanium and a halogen as essential components, and the like; and a catalyst system containing a solid catalyst component containing magnesium, titanium and a halogen as essential components, combined with an organoaluminum compound and depending on necessity a third component, such as an electron donating compound.

Examples of the solid catalyst component containing magnesium, titanium and a halogen as essential components include the catalyst systems described in JP-A-61-218606, JP-A-61-287904 and JP-A-7-216017.

Preferred examples of the organoaluminum compound include triethylaluminum, triisobutylaluminum, a mixture of triethylaluminum and diethylaluminum chloride, and tetraethyldialumoxane.

Examples of the electron donating compound include cyclohexylethyldimethoxysilane, tert-butyl-n-propyldimethoxysilane, tert-butylethyldimethoxysilane and dicyclopentyldimethoxysilane.

Examples of the polymerization method used in production of the propylene copolymer include a solution polymerization method using an inert solvent, representative examples of which include a hydrocarbon compound, such as hexane, heptane, octane, decane, cyclohexane, methylcyclohexane, benzene, toluene and xylene, a bulk polymerization method using a liquid monomer as a solvent, and a vapor phase polymerization method where polymerization is performed in a gaseous monomer, and a bulk polymerization method and a vapor phase polymerization method are preferred. The polymerization methods may be performed by a batch method or a continuous method.

The propylene copolymer preferably has an in-plane phase retardation of 20 nm or less as measured by the resin selection test shown below, for providing an optical film for protecting a polarizer having a high optical isotropy.

A propylene random copolymer may be preferably used in the optical film for protecting a polarizer of the present invention owing to the low birefringence thereof.

### Resin Selection Test

A specimen in a pellet form is molded by heat press to produce a film having a size of 10 cm square and a thickness of 100 μm. In the heat press molding, the resin is pre-heated at 220° C. for 5 minutes, then pressurized to 100 kgf/cm² over 3 minutes, maintained the pressure of 100 kgf/cm² for 2 minutes, and then cooled at 30° C. under a pressure of 30 kgf/cm² for 5 minutes. The in-plane phase retardation of the film thus produced is measured, thereby selecting a propylene copolymer having a low birefringence. The in-plane phase retardation is measured with a phase retardation measuring device under conditions of a wavelength of 589.3 nm and an incident angle of 0 degree.

The propylene copolymer preferably has a melt flow rate (MFR) of from 0.5 to 50 g per 10 minutes, and more preferably from 7 to 50 g per 10 minutes. When the MFR of the propylene copolymer is in the range, distortion is hard to occur upon forming an unstretched film, and thus an optical film having a low birefringence can be obtained. Furthermore, the optical film has a sufficient strength, which facilitates the post-processing. Moreover, the amount of an additive added, such as an MFR controlling agent, can be suppressed to prevent the properties from being deteriorated. The MFR of the mixture may be controlled with an ordinary MFR controlling agent, such as an organic peroxide.

The value of MFR is measured according to JIS K7210 under conditions of a temperature of 230° C. and a load of 21.18 N.

The width of the molecular weight distribution of the propylene copolymer may be evaluated by the ratio of the weight average molecular weight Mw with respect to the number average molecular weight Mn (dispersity), and Mw/Mn is preferably from 1 to 20.

Mn and Mw are measured with gel permeation chromatography (GPC) under conditions of o-dichlorobenzene at 140° C. as a solvent and polystyrene as the standard sample.

The propylene copolymer preferably has a melting point of from 120 to 170° C. When the melting point (Tm) is 120° C. or more, the optical film is improved in heat resistance and can be favorably used for the purpose of enhancing the heat resistance of the polarizing plate.

The melting point is evaluated by the temperature, at which the peak with the maximum intensity appears in the melting curve measured with a differential scanning calorimeter (DSC), and is obtained as the melting peak temperature when 10 mg of a pressed film of the propylene copolymer is heat-treated at 230° C. under a nitrogen atmosphere for 5 minutes, then cooled to 30° C. at a temperature decreasing rate of 10° C. per minute, maintained at 30° C. for 5 minutes, and then heated from 30° C. to 230° C. at a temperature increasing rate of 10° C. per minute.

The polypropylene resin may be a mixture of two or more kinds of the propylene copolymers. In this case, the polypropylene copolymers that are different in the kinds of comonomers, the proportion of the constitutional unit derived from propylene, the molecular weight, the tacticity and the like may be mixed. The polypropylene resin may contain homopolypropylene (i.e., a homopolymer of propylene) in such a range that does not impair the optical characteristics of the propylene copolymer.

### 2-(2H-Benzotriazol-2-yl)-4-(1,1,3,3-tetramethylbutyl)phenol

2-(2H-Benzotriazol-2-yl)-4-(1,1,3,3-tetramethylbutyl)phenol is a benzotriazole ultraviolet ray absorbent and is an essential component in the mixture constituting the optical film for protecting a polarizer of the present invention.

In general, an ultraviolet ray as light energy is classified in the order of decreasing wavelength into UV-A (380 to 315 nm), UV-B (315 to 280 nm) and UV-C (280 to 100 nm). The shorter wavelength component has the larger energy intensity, but since sunlight with a shorter wavelength is absorbed by the ozonosphere and oxygen in the atmosphere, an ultraviolet ray with a wavelength of 280 nm or less reaches the ground only in a small amount. The deterioration of the cellulose resin and the polypropylene resin constituting the polarizer is caused mostly by radiation of light having a wavelength of from 280 to 400 nm. The major absorption wavelengths of the polypropylene resin are 310 nm (UV-B region), 330 nm (W-A region) and 370 nm (W-A region), and for preventing the polypropylene resin from being deteriorated by an ultraviolet ray, it is important to absorb light in the UV-A region and the UV-B region with the ultraviolet ray absorbent added.

2-(2H-Benzotriazol-2-yl)-4-(1,1,3,3-tetramethylbutyl)phenol particularly absorbs light in the UV-A region and the UV-B region, and thus is a favorable ultraviolet ray absorbent.

2-(2H-Benzotriazol-2-yl)-4-(1,1,3,3-tetramethylbutyl)phenol does not impair the high optical characteristics of the propylene copolymer as another one of the essential components of the present invention, and it exerts a good ultraviolet ray absorbing capability and causes no bleed out upon molding the film, with an amount added in a prescribed range.

In the present invention, the content of 2-(2H-benzotriazol-2-yl)-4-(1,1,3,3-tetramethylbutyl)phenol is preferably 0.08% by mass or more based on the mixture for maintaining the prescribed ultraviolet ray absorbing capability. The content thereof is preferably 0.1% by mass or more for providing a favorable ultraviolet ray absorbing capability in the wide range including the UV-A region, the UV-B region and the UV-C region (for example, light transmittance in the ultraviolet range of less than 30%). The content thereof is more preferably 0.5% by mass or more for providing a more favorable ultraviolet ray absorbing capability in the wide range including the UV-A region, the UV-B region and the UV-C region (for example, light transmittance in the ultraviolet range of less than 10%).

For preventing bleed out of the ultraviolet ray absorbent from occurring upon molding the film, on the other hand, the content of 2-(2H-benzotriazol-2-yl)-4-(1,1,3,3-tetramethylbutyl)phenol is preferably 5.5% by mass or less. The content thereof is more preferably 1.5% by mass or less from the standpoint of cost.

In view of the above, the range of the content of 2-(2H-benzotriazol-2-yl)-4-(1,1,3,3-tetramethylbutyl)phenol is preferably from 0.08 to 5.5% by mass, and most preferably from 0.5 to 1.5% by mass, for providing an optical film for protecting a polarizer with high quality.

### Other Components

In the present invention, the mixture constituting the optical film for protecting a polarizer may contain depending on necessity various additives and additional resins as arbitrary components.

### Additional Organic Ultraviolet Ray Absorbent

The mixture may contain an organic ultraviolet ray absorbent other than 2-(2H-benzotriazol-2-yl)-4-(1,1,3,3-tetramethylbutyl)phenol in such a range that does not impair the optical characteristics of the propylene copolymer or does not provide any practical problem. The addition of plural ultraviolet ray absorbents that are different in ultraviolet ray absorbing characteristics is effective for providing a high ultraviolet ray absorbing capability over a wide range.

### Metal Oxide Ultraviolet Ray Absorbent

The mixture may contain a metal oxide ultraviolet ray absorbent. Preferred examples of the metal oxide ultraviolet ray absorbent include zinc oxide, titanium oxide, cerium oxide and iron oxide, and among these, zinc oxide and titanium oxide are preferred. The metal oxide ultraviolet ray absorbent may be used solely or after mixing two or more kinds thereof in an arbitrary ratio.

The average particle diameter of the metal oxide ultraviolet ray absorbent is preferably from 5 to 90 nm, and more preferably from 5 to 50 nm, for ensuring the ultraviolet ray absorbing capability while maintaining the good visible light transmittance. The average particle diameter of the ultraviolet ray absorbing metal oxide is preferably as small as possible from the aforementioned view point, but the lower limit thereof may be 5 nm from the standpoint of cost. The average particle diameter herein is an arithmetic average diameter (i.e., a number average value) obtained in such a manner that a dispersion liquid containing carbon black sufficiently diluted and dispersed in a solvent, such as chloroform, is spread and dried on a mesh with a collodion membrane, and then observed with a transmission electron microscope (TEM) to provide a TEM micrograph thereof, which is subjected to computer image analysis to provide the particle diameters as diameters of circles each having the same area as the aggregated bodies thus extracted (i.e., the equiareal circle diameters), and the arithmetic average diameter is calculated from the resulting particle diameter distribution.

The content of the metal oxide ultraviolet ray absorbent is generally preferably approximately from 0.08 to 5.5% by mass based on the mixture for providing favorable transparency while ensuring a good ultraviolet ray absorbing capability of the optical film.

For providing the metal oxide ultraviolet ray absorbent, a powder raw material may be generally used. The metal oxide ultraviolet ray absorbent in a powder form is poor in dispersibility, and it is necessary to prepare a master batch of the polypropylene resin and the metal oxide ultraviolet ray absorbent in advance before kneading with the polypropylene resin. The content of the metal oxide ultraviolet ray absorbent upon preparing the master batch is preferably 50% by mass or less, and more preferably 20% by mass or less, based on the mixture of the polypropylene resin and the metal oxide ultraviolet ray absorbent. When the content of the metal oxide ultraviolet ray absorbent is in the range, good dispersibility of the metal oxide ultraviolet ray absorbent is obtained in the master batch.

### Sorbitol Additive

The mixture may contain a sorbitol additive for enhancing the tensile strength and for enhancing the transparency. The sorbitol additive is preferably a dibenzylidene sorbitol additive, which affects the phase difference only slightly.

Preferred examples of the dibenzylidene sorbitol additive include 1,3-2,4-dibenzylidene sorbitol, a di-substituted dibenzylidene sorbitol, such as 1,3-2,4-di-p-methyldibenzylidene sorbitol, and a mixture of a di-substituted benzylidene sorbitol and a diglycerin monofatty acid ester.

It has been known that the dibenzylidene sorbitol additive functions as a clearing nucleating agent, which contributes to the enhancement of the transparency and enhancement of the strength of the polypropylene resin, and it is found that the use thereof in the optical film for protecting a polarizer causes substantially no influence on the phase difference.

In the dibenzylidene sorbitol additive, a dibenzylidene sorbitol nucleating agent added with a diglycerin monofatty acid ester, which provides less bleed out and is stable, is preferred. Examples of the diglycerin monofatty acid ester include diglycerin monolaurate ester, diglycerin monomyristate ester and diglycerin monostearate ester, which may be used solely or as a mixture thereof.

The content of the sorbitol additive is preferably from 0.03 to 0.5 part by mass, and more preferably from 0.05 to 0.25 part by mass, per 100 parts by mass of the mixture. When the content is 0.03 part by mass or more, enhancement of the transparency and sufficient enhancement of the strength can be achieved. When the content is 0.5 part by mass or less, it is advantageous in cost since enhancement of the transparency and enhancement of the strength can be achieved efficiently.

In the case where a di-substituted benzylidene sorbitol added with a diglycerin monofatty acid ester is used, the content of the di-substituted benzylidene sorbitol is preferably from 0.03 to 0.3 part by mass based on the composition, and the content of the diglycerin monofatty acid ester mixed is preferably from 0.01 to 0.2 part by mass based on the polypropylene resin composition.

The dibenzylidene sorbitol additive is preferably used by granulating it solely or after mixing for enhancing the dispersibility in the polypropylene resin mixture. The granulation may be performed by such a method as melt extrusion granulation, dry extrusion granulation and compression granulation.

### Various Olefin Resins and Additives

The mixture of the present invention may contain various kinds of olefin resins and additives depending on the demanded properties of the optical film for protecting a polarizer in such a range that does not impair the necessary optical characteristics.

Examples of the additives include a weather resistance improving agent, a wear resistance improving agent, a polymerization inhibitor, a crosslinking agent, an infrared ray absorbent, an antistatic agent, an adhesion improving agent, a leveling agent, a thixotropy imparting agent, a coupling agent, a surfactant, a polymer electrolyte, an electroconductive complex, an antiblocking agent, a lubricant, a plasticizer, a defoaming agent, a filler and a solvent.

The weather resistance improving agent used may be, for example, a light stabilizer. The light stabilizer is preferably a hindered amine light stabilizer (HALS). The hindered amine light stabilizer (HALS) functions as a radical capture agent. Examples of the hindered amine light stabilizer (HALS) include N,N′,N″,N″′-tetrakis(4,6-bis(butyl-(N-methyl-2,2,6,6-tetramethylpiperidin-4-yl)amino)triazin-2-yl)-4,7-diazadecane-1,10-diamine, a polycondensate of dibutylamine-1,3,5-triazine-N,N′-bis(2,2,6,6-tetramethyl-4-piperidyl-1,6-hexamethylenediamine and N-(2,2,6,6-tetramethyl-4-piperidyl)butylamine, poly((6-(1,1,3,3-tetramethylbutyl)amino-1,3,5-triazin-2,4-diyl)((2,2,6,6-tetramethyl-4-piperidyl)imino)-hexamethylene ((2,2,6,6-tetramethyl-4-piperidyl)imino)), polymer of dimethyl succinate and 4-hydroxy-2,2,6,6-tetramethyl-1-piperidineethanol, a reaction product of (2,2,6,6-tetramethyl-1-(octyloxy)-4-piperidinyl) decanedioate, 1,1-dimethylethylhydroperoxyde and octane, bis(1,2,2,6,6-pentamethyl-4-piperidyl) ((3,5-bis(1,1-dimethylethyl)-4-hydroxyphenyl)methyl) butylmalonate, a mixture of bis(1,2,2,6,6-pentamethyl-4-piperidyl) sebacate and methyl 1,2,2,6,6-pentamethyl-4-piperidyl sebacate, bis(2,2,6,6-pentamethyl-4-piperidyl) sebacate, bis(1,2,2,6,6-pentamethyl-4-piperidyl) 2-(3,5-di-tert-butyl-4-hydroxybenzyl)-2′-n-butylmalonate, bis(1,2,2,6,6-pentamethyl-4-piperidyl) sebacate, and tetrakis(2,2,6,6-tetramethyl-4-piperidyl)-1,2,3,4-butane tetracarboxylate. A reactive compound having a polymerizable group, such as a (meth)acryloyl group, in the molecule may also be used as a light stabilizer.

Examples of the wear resistance improving agent as an inorganic material include spherical particles of α-alumina, silica, kaolinite, iron oxide, diamond, silicon carbide and the like. Examples of the shape of the particles include a sphere, an ellipsoid, a polyhedron and scaly shape without particular limitation, and a spherical shape is preferred. Examples thereof as an organic material include synthetic resin beads, such as a crosslinked acrylic resin and a polycarbonate resin. The particle diameter is generally approximately from 30 to 200% of the thickness of the optical film. Among these, spherical α-alumina is particularly preferred since it exerts a large effect on enhancement of the wear resistance owing to the high hardness thereof, and spherical particles thereof can be relatively easily provided.

Examples of the polymerization inhibitor include hydroquinone, p-benzoquinone, hydroquinone monomethyl ether, pyrogallol and t-butylcatechol, and examples of the crosslinking agent include a polyisocyanate compound, an epoxy compound, a metal chelate compound, an aziridine compound and an oxazoline compound.

Examples of the filler include barium sulfate, talc, clay, calcium carbonate and aluminum hydroxide.

Examples of the infrared ray absorbent include a dithiol metal complex, a phthalocyanine compound and a dimmonium compound.

In addition to the above, various additives may be added to the mixture to impart various functions to the optical film for protecting a polarizer. Examples thereof include a so-called hard coat function having high hardness and scratch resistance, an anti-fogging coat function, an anti-fouling coat function, an anti-glare coat function, an anti-reflection coat function, an ultraviolet ray shielding coat function and an infrared ray shielding coat function.

### Optical Film for Protecting Polarizer

The thickness of the optical film for protecting a polarizer is preferably in a range of from 10 to 200 μm, and more preferably from 30 to 150 μm. When the thickness is 10 μm or more, the protection strength of the optical film for protecting a polarizer is sufficiently ensured, and when it is 200 μm or less, sufficient flexibility is obtained, and the optical film has good handleability owing to the lightweight thereof and is advantageous in cost.

The optical film for protecting a polarizer can be controlled to have an intended bending elastic modulus, for example, by using such a method as a method of selecting the polypropylene resin depending on the characteristics derived therefrom (such as the crystallinity and the average molecular weight), a method of adding a filler selected from inorganic and organic fillers to the resin, a method of adding a crosslinking agent or the like, a method of mixing two or more kinds of resins that are different in elastic modulus, and a method of selecting the plasticizer component of the curable resin, or by using a combination of these methods.

The bending elastic modulus of the optical film for protecting a polarizer is preferably 700 MPa or more. When the bending elastic modulus is in the range, a sufficient rigidity upon handling the film can be obtained to facilitate the post-processing, and scratch resistance sufficient for functioning as a protective sheet of a polarizing plate can be obtained. Furthermore, the bending elastic modulus of the optical film for protecting a polarizer is more preferably 900 MPa or more. When the bending elastic modulus is 900 MPa or more, the in-plane phase difference can be stabilized upon producing the film by T-die extrusion molding.

In the present invention, the bending elastic modulus is measured according to JIS K7171.

The optical film for protecting a polarizer preferably has a tensile strength of 20 MPa or more. When the tensile strength is 20 MPa or more, the optical film for protecting a polarizer does not undergo orientation upon adhering the optical film for protecting a polarizer to a polarizer through an adhesive layer by a roll-to-roll method, upon molding the film for protecting a polarizer, and thus the optical film is hard to suffer generation of phase difference, thereby maintaining the capability of the polarizing plate.

In the present invention, the tensile strength is measured according to ASTM D638 (Type 4 condition).

The optical film for protecting a polarizer may be subjected to an adhesion facilitating treatment for enhancing the adhesion property on the surface in contact with a polarizer. Examples of the adhesion facilitating treatment include a surface treatment, such as a corona treatment, a plasma treatment, a low pressure UV treatment and a saponification treatment, and a method of forming an anchoring layer, which may be employed in combination. Among these, a corona treatment, a method of forming an anchoring layer, and a combination thereof are preferred.

In the case where an adhesive layer is formed for enhancing the adhesiveness between the optical film for protecting a polarizer and a polarizer, an adhesive may be coated on one side or both sides of the optical film for protecting a polarizer and the polarizer.

The optical film for protecting a polarizer and the polarizer are adhered to each other through the surface having been subjected to the adhesion facilitating treatment or the surface having the adhesive layer formed thereon, and then the assembly is subjected to a drying treatment, thereby forming an adhesive layer formed of the dried adhesive. They may be adhered to each other after forming the adhesive layer. The polarizer and the optical film for protecting a polarizer may be adhered to each other with a roll laminator or the like. The heating and drying temperature and the drying time may be appropriately determined depending on the kind of the adhesive.

Too large the thickness of the adhesive layer is not preferred from the standpoint of adhesiveness of the optical film for protecting a polarizer, and thus the thickness thereof after drying is preferably from 0.01 to 10 μm, and more preferably from 0.03 to 5 μm.

A functional layer may be laminated on the surface of the optical film for protecting a polarizer, thereby imparting a so-called hard coat function having high hardness and scratch resistance, an anti-fogging coat function, an anti-fouling coat function, an anti-glare coat function, an anti-reflection coat function, an ultraviolet ray shielding coat function, an infrared ray shielding coat function, and the like.

### Production Method of Optical Film for Protecting Polarizer

The optical film for protecting a polarizer may be produced in such a manner that the polypropylene resin containing the propylene copolymer, 2-(2H-benzotriazol-2-yl)-4-(1,1,3,3-tetramethylbutyl)phenol and depending on necessity various additives and additional resins are mixed and melted under heating, and then molded by various molding methods, such as an extrusion coating molding method, a casting method, a T-die extrusion molding method, an inflation method and an injection molding method.

In the present invention, the optical film for protecting a polarizer produced on a polarizer is demanded not to be oriented, and therefore, an unstretching T-die extrusion molding method is preferred.

### Polarizing Plate

The polarizing plate of the present invention contains the optical film for protecting a polarizer formed on at least one surface of a polarizer. The optical film for protecting a polarizer may be formed by directly forming the optical film for protecting a polarizer on a polarizer, or by producing the optical film for protecting a polarizer in advance, and then adhering the optical film to a polarizer through an adhesive layer.

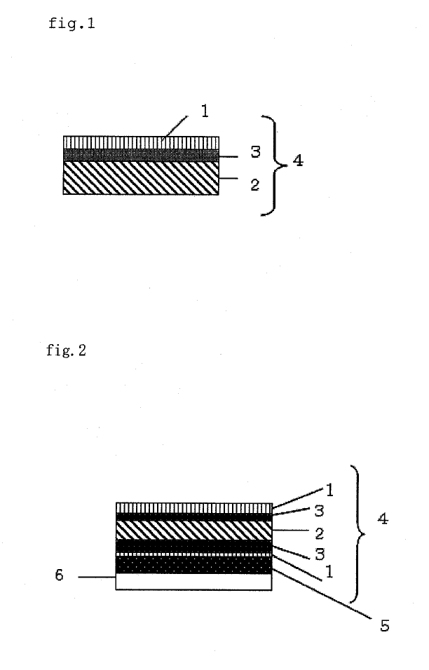

FIG. 1 shows an example of a polarizing plate according to the present invention. In FIG. 1, numeral 2 denotes a polarizer, and an optical film for protecting a polarizer 1 is formed on one surface thereof through an adhesive layer 3, thereby constituting the polarizing plate 4 in total.

The polarizer used in the polarizing plate may be any type of a polarizer that has a function of transmitting light having a particular vibration direction, and examples thereof include a PVA polarizer obtained by stretching a PVA film or the like and dyeing the film with iodine or a dichroic dye; a polyene polarizer, such as a dehydrated product of PVA and a dehydrochloric acid treatment product of polyvinyl chloride; a reflective polarizer using a cholesteric liquid crystal; and a thin crystalline film polarizer, with the PVA polarizer being preferably used among these.

Examples of the PVA polarizer include a hydrophilic polymer film, such as a PVA film, a partially formalated polyvinyl alcohol film and a partially saponified ethylene-vinyl acetate copolymer film, that is adsorbed with a dichroic substance, such as iodine and a dichroic dye, and then uniaxially stretched. Among these, a polarizer containing a PVA film and a dichroic substance, such as iodine, is preferably used. The thickness of the polarizer is not particularly limited and is generally approximately from 1 to 100 μm.

The PVA resin that is preferably used as a resin for constituting the polarizer is obtained by saponifying a polyvinyl acetate resin. Examples of the polyvinyl acetate resin include polyvinyl acetate as a homopolymer of vinyl acetate, and a copolymer of vinyl acetate and another monomer capable of being copolymerized therewith. Examples of the another monomer copolymerized with vinyl acetate include an unsaturated carboxylic acid, an olefin, a vinyl ether and an unsaturated sulfonic acid.

The saponification degree of the PVA resin is generally in a range of from 85 to 100% by mol, and preferably from 98 to 100% by mol. The PVA resin may further be modified, and for example, polyvinyl formal, polyvinyl acetal and the like modified with an aldehyde compound may be used. The polymerization degree of the PVA resin is generally in a range of from 1,000 to 10,000, and preferably from 1,500 to 10,000.

The polarizing plate may be produced, for example, through a step of uniaxially stretching the PVA film, step of dyeing the PVA resin film with a dichroic colorant to adsorb the dichroic colorant, a step of treating the PVA film having the dichroic colorant adsorbed thereon with a boric acid aqueous solution, a step of rinsing with water after treating with a boric acid aqueous solution, and a step of adhering the optical film for protecting a polarizer to the uniaxially stretched and oriented PVA film having the dichroic colorant adsorbed thereon through these steps.

The uniaxially stretching may be performed before dyeing with a dichroic colorant, simultaneously with dyeing with a dichroic colorant, or after dyeing with a dichroic colorant. In the case where the uniaxially stretching is performed after dyeing with a dichroic colorant, the uniaxially stretching may be performed before treating with boric acid or during the boric acid treatment. The uniaxially stretching may be performed in these plural stages. For performing the uniaxially stretching, the film may be uniaxially stretched between rolls different in circumferential velocity, or may be uniaxially stretched with a heat roll. The uniaxially stretching may be dry stretching performed in the air or wet stretching performed in a state where the film is swollen with a solvent. The stretching ratio is generally approximately from 4 to 8 times.

The PVA film may be dyed with a dichroic colorant, for example, by immersing the PVA film in an aqueous solution containing the dichroic colorant. Specific examples of the dichroic colorant used include iodine and a dichroic dye.

In the case where iodine is used as the dichroic colorant, such a method may be generally employed that the PVA film is dyed by immersing in an aqueous solution containing iodine and potassium iodide. The content of iodine in the aqueous solution is generally approximately from 0.01 to 0.5 parts by mass per 100 parts by mass of water, and the content of potassium iodide therein is generally approximately from 0.5 to 10 parts by mass per 100 parts by mass of water. The temperature of the aqueous solution is generally approximately from 20 to 40° C., and the period of time of immersing in the aqueous solution is generally approximately from 30 to 300 seconds.

In the case where a dichroic dye is used as the dichroic colorant, such a method may be employed that the PVA film is dyed by immersing in an aqueous solution containing a water soluble dichroic dye. The content of the dichroic dye in the aqueous solution is generally approximately from 1×10⁻³ to 1×10⁻² part by mass per 100 parts by mass of water. The aqueous solution may contain an inorganic salt, such as sodium sulfate. The temperature of the aqueous solution is generally approximately from 20 to 80° C., and the period of time of immersing in the aqueous solution is generally approximately from 30 to 300 seconds.

The boric acid treatment after dyeing with a dichroic dye may be performed by immersing the dyed PVA film in a boric acid aqueous solution. The content of the boric acid in the boric acid aqueous solution is generally approximately from 2 to 15 parts by mass, and preferably approximately from 5 to 12 parts by mass, per 100 parts by mass of water.

In the case where iodine is used as the dichroic colorant, the boric acid aqueous solution preferably contains potassium iodide. The content of potassium iodide in the boric acid aqueous solution is generally approximately from 2 to 20 parts by mass, and preferably from 5 to 15 parts by mass, per 100 parts by mass of water. The period of time of immersing in the boric acid aqueous solution is generally approximately from 100 to 1,200 seconds, preferably approximately from 150 to 600 seconds, and more preferably approximately from 200 to 400 seconds. The temperature of the boric acid aqueous solution is generally 50° C. or more, and preferably from 50 to 85° C.

The PVA film after subjecting to the boric acid treatment is generally rinsed with water. The water rinsing treatment may be performed, for example, by immersing the PVA film having been subjected to the boric acid treatment in water. After water rinsing, the film is dried to provide a polarizer. The temperature of water in the water rinsing treatment is generally approximately from 5 to 40° C., and the period of time of immersion is generally approximately from 2 to 120 seconds. The drying treatment performed thereafter may be generally performed by using a hot air dryer or a far infrared ray heater. The drying temperature is generally from 40 to 100° C. The treating time in the drying treatment is generally approximately from 120 to 600 seconds.

Thus, the polarizer containing the oriented PVA film having iodine or a dichroic dye adsorbed thereon is obtained.

The method of adhering the polarizer and the optical film for protecting a polarizer may be performed with an adhesive layer. Examples of an adhesive for forming the adhesive layer include a PVA adhesive, an epoxy adhesive, an acrylic adhesive, a polyolefin having an unsaturated carboxylic acid or an anhydride thereof grafted thereon, and a polyolefin adhesive mixed with the grafted polyolefin. Examples thereof also include adhesives having transparency, such as a polyvinyl ether adhesive and a rubber adhesive. Among these, a PVA adhesive is preferred.

The PVA adhesive contains a PVA resin and a crosslinking agent, and examples of the PVA resin include PVA obtained by saponifying polyvinyl acetate and a derivative thereof, a saponified product of a copolymer of vinyl acetate and a monomer having copolymerizability therewith, and modified PVA obtained by acetalization, urethanization, etherifyication, grafting or phosphate esterification of PVA. The PVA resins may be used solely or as a combination of two or more kinds thereof. Examples of the monomer having copolymerizability with vinyl acetate include an unsaturated carboxylic acid, such as maleic acid (or maleic anhydride), fumaric acid, crotonic acid, itaconic acid and (meth)acrylic acid, an ester of the unsaturated carboxylic acid, an α-olefin, such as ethylene and propylene, (meth)allylsulfonic acid (or sodium (meth)allylsulfonate), sodium sulfonate (or sodium sulfonate monoalkyl maleate), sodium disulfonate alkyl maleate, N-methylolacrylamide, acrylamide alkylsulfonate alkali salt, N-vinylpyrrolidone and an N-vinylpyrrolidone derivative.

While the polymerization degree and the like of the PVA resin are not particularly limited, one having an average polymerization degree of approximately from 100 to 3,000, and preferably from 500 to 3,000, and an average saponification degree of approximately from 85 to 100% by mol, and preferably approximately from 90 to 100% by mol, is preferably used since the adhesion property and the like are improved.

Examples of the epoxy adhesive include a hydrogenated epoxy resin, an alicyclic epoxy resin and an aliphatic epoxy resin. The epoxy resin may further contain a compound accelerating cationic polymerization, such as an oxetane compound and a polyol compound.

Preferred examples of the acrylic adhesive include ones containing mainly a copolymer of an acrylate ester, such as butyl acrylate, ethyl acrylate, methyl acrylate and 2-ethylhexyl acrylate, and an α-monoolefincarboxylic acid, such as acrylic acid, maleic acid, itaconic acid, methacrylic acid and crotonic acid (including ones having a vinyl monomer, such as acrylonotrile, vinyl acetate and styrene, added thereto), since these do not impair the polarization characteristics of the polarizer.

A polyolefin having an unsaturated carboxylic acid or an anhydride thereof grafted thereon, and a polyolefin adhesive mixed with the grafted polyolefin may be used as the adhesive. Examples of the polyolefin used for grafting include low density polyethylene, high density polyethylene, polypropylene polymerized with a Ziegler catalyst or a metallocene catalyst, poly-1-butene, poly-4-methyl-1-pentene, an ethylene-propylene copolymer, an ethylene-1-butene copolymer, a propylene-1-butene copolymer, and mixtures thereof. Examples of the unsaturated carboxylic acid or an anhydride thereof used for grafting with the polyolefin include acrylic acid, methacrylic acid, maleic acid, maleic anhydride, citraconic acid, citraconic anhydride, itaconic acid and itaconic anhydride. The modified polyolefin thus obtained may be used as it is or may be used after mixing in a polyolefin.

In the present invention, the polarizer and the adhesive layer may be imparted with an ultraviolet ray absorbing capability, for example, by a method of treating with an ultraviolet ray absorbent, such as a salicylate ester compound, a benzophenol compound, a benzotriazole compound, a cyanoacrylate compound and a nickel complex salt compound.

The adhesive layer is formed by coating an adhesive on one side or both sides of the optical film for protecting a polarizer and the polarizer. The thickness of the adhesive layer is preferably from 0.01 to 10 μm, and more preferably from 0.03 to 5 μm.

Upon adhering the optical film for protecting a polarizer to the polarizer, the surface of the optical film for protecting a polarizer that is in contact with the polarizer may be subjected to an adhesion facilitating treatment for enhancing the adhesion property. Examples of the adhesion facilitating treatment include a surface treatment, such as a corona treatment, a plasma treatment, a low pressure UV treatment and a saponification treatment, and a method of forming an anchoring layer, which may be employed in combination. Among these, a corona treatment, a method of forming an anchoring layer, and a combination thereof are preferred.

The adhesive layer is then formed on the surface having been subjected to the adhesion facilitating treatment, and the polarizer and the optical film for protecting a polarizer are adhered to each other through the adhesive layer.

The polarizer and the optical film for protecting a polarizer may be adhered to each other with a roll laminator or the like. The heating and drying temperature and the drying time may be appropriately determined depending on the kind of the adhesive.

The polarizing plate having the optical film for protecting a polarizer of the present invention formed on one surface of the polarizer may have on the other surface of the polarizer, depending on necessity, the optical film for protecting a polarizer of the present invention formed thereon, or a film containing another resin formed thereon. Examples of the film containing another resin include a fumarate diester resin film, a cellulose triacetate film, polyether sulfone film, a polyarylate film, a polyethyleneterephthalate film, a polynaphthaleneterephthalate film, a polycarbonate film, a cyclic polyolefin film, a maleimide resin film and a fluorine resin film. The film containing another resin may be a phase retardation film having a particular phase difference.

The polarizing plate is preferably a laminated body having at least one layer of a hard coat layer for enhancing the surface property and the scratch resistance. Examples of the hard coat layer include hard coat layers formed of a silicone resin, an acrylic resin, an acrylic silicone resin, an ultraviolet ray curable resin, a urethane hard coat agent and the like, and among these, a hard coat layer formed of an ultraviolet ray curable resin is preferred from the standpoint of the transparency, the scratch resistance and the chemical resistance. The hard coat layer may be formed of one of the aforementioned resins solely or of a mixture of two or more kinds thereof.

Examples of the ultraviolet ray curable resin include at least one of ultraviolet ray curable resins selected from an ultraviolet ray curable acrylic urethane, an ultraviolet ray curable epoxy acrylate, an ultraviolet ray curable (poly)ester acrylate, an ultraviolet ray curable oxetane and the like.

The thickness of the hard coat layer is preferably from 0.1 to 100 μm, particularly preferably from 1 to 50 μm, and further preferably from 2 to 20 μm. A primer treatment may be performed between the hard coat layer and the other layer.

The polarizing plate may be subjected to a known anti-glare treatment, such as an anti-reflection treatment and a low reflection treatment depending on necessity.

### Image Display Apparatus

The polarizing plate of the present invention may be preferably used in various kinds of apparatus for displaying an image.

The image display apparatus is not particularly limited in kind of the image display apparatus as far as it uses a polarizing plate, and examples thereof include a liquid crystal display including a liquid crystal cell, an organic electroluminescence (which is hereinafter referred to as “organic EL”) display apparatus, and a touch sensitive panel. The liquid crystal display is ordinarily constituted by assembling constitutional components, such as a liquid crystal cell, an optical film and depending on necessity an illumination system, to which a driving circuit is installed, and in the present invention, the structure of the image display apparatus is not particularly limited except for the use of the polarizing plate described above. Examples thereof include an image display apparatus having the polarizing plate disposed on one side or both sides of a liquid crystal cell, and an image display apparatus having a backlight or a reflection plate as the illumination system. The liquid crystal cell used may be an arbitrary one, such as a TN type, an STN type and a it type. Upon constituting the image display apparatus, for example, one layer or two or more layers of each of appropriate components, such as a diffusion plate, an anti-glare layer, an anti-reflection layer, protective plate, a prism array, a lens array sheet, a light diffusion plate and a backlight, may be disposed.

### Liquid Crystal Display Including Liquid Crystal Cell

The polarizing plate of the present invention may be used, for example, by laminating with a liquid crystal cell or the like.

As an example of the image display apparatus of the present invention, FIG. 2 shows a structural example of a liquid crystal display including a liquid crystal cell. In FIG. 2, numeral 6 denotes a liquid crystal cell. Examples of the liquid crystal cell 6 include an active matrix driving type, representative examples of which include a thin film transistor type, and a simple matrix driving type, representative examples of which include a twisted nematic type and a super twisted nematic type. On the liquid crystal cell 6, a phase retardation film (birefringence plate) 5 is laminated through an adhesive layer (which is not shown in the figure), and further thereon, a polarizing plate 4 is laminated through an adhesive layer (which is not shown in the figure). The polarizing plate 4 has a polarizer 2 at the center thereof, and on both surfaces thereof optical films for protecting a polarizer 1 laminated through adhesive layers 3. Upon laminating the polarizing plate 4 and the phase retardation film 5, and the phase retardation film 5 and the liquid crystal cell 6, a pressure sensitive adhesive layer may be provided on the polarizing plate 4, the phase retardation film 5 and the liquid crystal cell 6 in advance.

The pressure sensitive adhesive for laminating the polarizing plate and the liquid crystal cell is not particularly limited, and examples thereof include ones containing a base polymer selected from such polymers as an acrylic polymer, a silicone polymer, polyester, polyurethane, polyamide, polyether, a fluorine polymer and a rubber polymer, which may be appropriately selected. Among these, an acrylic pressure sensitive adhesive is preferred since it is excellent in optical transparency, shows appropriate pressure sensitive adhesion properties including wettability, cohesiveness and adhesiveness, and is excellent in weather resistance and heat resistance.

The pressure sensitive adhesive is demanded to be excellent in optical transparency, appropriate pressure sensitive adhesion properties including wettability, cohesiveness and adhesiveness, and excellent weather resistance and heat resistance. Furthermore, such a pressure sensitive adhesive layer is demanded that has a low hygroscopic rate and is excellent in heat resistance, from the standpoint of prevention of a foaming phenomenon and a releasing phenomenon due to moisture absorption, prevention of deterioration of the optical characteristics and warpage of the liquid crystal cell due to the difference in thermal expansion, and formation of an image display apparatus that has high quality and excellent durability.

The pressure sensitive adhesive may contain additives, for example, a natural or synthetic resin, particularly a pressure sensitive adhesiveness imparting resin, a filler and a pigment, such as glass fibers, glass beads, metal powder and other inorganic powder, a colorant, and an antioxidant. A pressure sensitive adhesive layer that exhibits light diffusion property owing to fine particles contained may also be used. The pressure sensitive adhesive layer may be imparted with an ultraviolet ray absorbing capability, for example, by a method of treating with an ultraviolet ray absorbent, such as a salicylate ester compound, a benzophenol compound, a benzotriazole compound, a cyanoacrylate compound and a nickel complex salt compound.

The coating method of the pressure sensitive adhesive onto the polarizing plate is not particularly limited, and may be performed by an appropriate method. Examples of the method include a method, in which a pressure sensitive adhesive solution having a concentration of approximately from 10 to 40% by mass is prepared by dissolving or dispersing the base polymer or a composition thereof in a solvent containing a sole solvent, such as toluene, ethyl acetate or the like, or a mixture thereof, and is coated directly on the polarizing plate by an appropriate spreading method, such as a flow casting method and a coating method, and a method, in which pressure sensitive adhesive layer is formed according to the above method on a releasable base film, and is then transferred to the polarizing plate.

Examples of the coating method include various methods, such as gravure coating, bar coating, roll coating, reverse roll coating and comma coating, and gravure coating may be most ordinarily employed.

The pressure sensitive adhesive layer may be a laminated layer containing ones different in composition or kind, and may be provided on one surface or both surfaces of the polarizing plate. In the case where it is provided on both surfaces, the compositions of the pressure sensitive adhesive layers on the front and back surfaces of the polarizing plate may not be the same as each other in composition, and may not be the same as each other in thickness. The pressure sensitive adhesive layers that are different in composition and thickness may be used.

The thickness of the pressure sensitive adhesive layer may be appropriately determined depending on the purpose and the adhesion force, and is generally from 1 to 500 μm, preferably from 5 to 200 μm, and particularly preferably from 10 to 100 μm.

The exposed surface of the pressure sensitive adhesive layer is preferably covered with a releasable film temporarily adhered thereto for preventing contamination or the like before subjecting to practical use. According to the procedure, the pressure sensitive adhesive layer may be prevented from being touched in an ordinary handling operation. The releasable film may be any known one, examples of which include a thin sheet body, such as a plastic film, a rubber sheet, paper, a cloth, a nonwoven cloth, a net, a foamed sheet, a metal foil and laminated bodies thereof, coated depending on necessity with a releasing agent, such as a silicone series, a long chain alkyl series, a fluorine series and a molybdenum sulfide series.

### Organic EL Display Apparatus

The polarizing plate of the present invention may be favorably used in an organic EL display apparatus.

In general, an organic EL display apparatus contains a transparent substrate having a transparent electrode, an organic luminescent layer and a metal electrode, which are accumulated in this order thereon to form a luminescent body (i.e., an organic electroluminescent body). The organic luminescent layer is a laminated body containing various organic thin films, and known examples thereof include a laminated body containing a hole injection layer formed of a triphenylamine derivative or the like and a luminescent layer formed of a fluorescent organic solid, such as anthracene, a laminated body containing the luminescent layer and an electron injection layer formed of a perylene derivative or the like, and a laminated body containing the hole injection layer, the luminescent layer and the electron injection layer.

The organic EL display apparatus emits light by the following principle. A voltage is applied to the transparent electrode and the metal electrode, thereby injecting holes and electrons to the organic luminescent layer. The energy generated through recombination of the holes and the electrons excites the fluorescent substance, and light is emitted upon returning the excited fluorescent substance to the ground state. The mechanism of recombination in the principle is the same as in an ordinary diode, and as expected from the mechanism, the electric current and the luminescent intensity show strong nonlinearity with respect to the applied voltage associated with rectification.

In the organic EL display apparatus, at least one of the electrodes is necessarily transparent for taking out the emitted light from the organic luminescent layer, and in general, a transparent electrode formed of a transparent electroconductive material, such as indium tin oxide (ITO), is used as the anode. For facilitating the electron injection to enhance the luminescent efficiency, it is important to use a substance with a small work function in the cathode, and in general, a metal electrode, such as Mg—Ag and Al—Li, is used therefor.

In the organic EL display apparatus having the structure, the organic luminescent layer is formed of an extremely thin film having a thickness of approximately 10 nm. Accordingly, the organic luminescent layer transmits light substantially completely, as similar to the transparent electrode. Consequently, in the non-light emission state, light incident on the surface of the transparent substrate is transmitted through the transparent electrode and the organic luminescent layer and reflected by the metal electrode, and is again emitted outward from the surface of the transparent substrate, and thus on viewing the display surface of the organic EL display apparatus from the outside, the display surface seems like a mirror surface.

In the organic EL display apparatus containing an organic electroluminescent body having a transparent electrode on the front surface side of the organic luminescent layer emitting light upon application of voltage and having a metal electrode on the back surface side of the organic luminescent layer, a polarizing plate may be provided on the front surface side of the transparent electrode, and a birefringence layer (i.e., a phase retardation film) may be provided between the transparent electrode and the polarizing plate.

The polarizing plate has a function of polarizing light that is incident from the outside and is reflected by the metal electrode, and thus the mirror surface of the metal electrode is prevented from being viewed from the outside owing to the polarizing function. In particular, when the birefringence layer is constituted by a λ/4 plate, and the angle between the polarizing directions of the polarizing plate and the birefringence layer is controlled to π/4, the mirror surface of the metal electrode can be completely shielded.

That is, only the linearly polarized component of the external light incident on the organic EL display apparatus is transmitted by the polarizing plate. The linearly polarized light generally becomes elliptically polarized light through the birefringence layer, but becomes circularly polarized light when the birefringence layer is a λ/4 plate, and the angle with respect to the polarizing direction of the polarizing plate is π/4. The circularly polarized light is transmitted through the transparent substrate, the transparent electrode and the organic thin film, reflected by the metal electrode, and again transmitted through the organic thin film, the transparent electrode and the transparent substrate, and then again becomes linearly polarized light in the birefringence layer. The linearly polarized light is perpendicular to the polarizing direction of the polarizing plate, and thus cannot be transmitted through the polarizing plate. As a result, the mirror surface of the metal electrode can be completely shielded.

### Touch Sensitive Panel

The polarizing plate of the present invention may be favorably used in a touch sensitive panel.

In general, a touch sensitive panel is for operating a device or a system by touching a transparent surface provided on a display screen with a pen or a finger by an operator. The operation of touching directly a screen is more direct and more intuitive than the operation of defining a position of a cursor by pressing cursor keys, and thus is being frequently used in recent years. Furthermore, in recent years, the market of a portable device, such as a portable phone and PDA (personal digital assistants), is growing significantly, and visibility under sunlight and a thin and lightweight configuration are strongly demanded. The touch sensitive panel includes various systems, which are selected appropriately depending on advantages and disadvantages thereof. The touch sensitive panel includes such systems as a resistive film type, an optical type, an electrostatic capacitive coupling type (which may also be referred to as an analog capacitive coupling type), an infrared ray type, an ultrasonic type and an electromagnetic induction type. A touch sensitive panel of a resistive film type as an example will be described herein.

The resistive film type touch sensitive panel includes a glass/glass type and a glass/film type. The glass/glass type contains a glass substrate having a transparent electroconductive layer and a glass substrate having a transparent electroconductive layer, which are retained with a space between them, and the assembly is mounted on the surface of the display. The glass/film type is provided owing to the demand of lightweight and thin profile of a touch sensitive panel for vehicle or portable use, and contains an optical film instead of the upper glass substrate having a transparent electroconductive layer.

When a linearly polarizing plate or a circularly polarizing plate combining and laminating a polarizing plate and a λ/4 plate is used as the outermost surface of the touch sensitive panel, the sufficient strength as the touch sensitive panel is obtained, and the visibility is enhanced by the antireflection effect. The optical film for protecting a polarizer of the present invention may be favorably used as the polarizing plate of the touch sensitive panel.

A circularly polarizing plate is obtained by laminating a polarizing plate containing the optical film for protecting a polarizer of the present invention and a polarizer with a λ/4 plate in such a manner that the angle between the in-plane phase retardation axis of the λ/4 plate and the polarizing axis of the polarizing plate is controlled to substantially 45°. The term substantially 45° means from 40 to 50°. The angle between the in-plane phase retardation axis of the λ/4 plate and the polarizing axis of the polarizing plate is preferably from 41 to 49°, more preferably from 42 to 48°, further preferably from 43 to 47°, and most preferably from 44 to 46°.

The optical film for protecting a polarizer of the present invention may be used above or under the protective film of the polarizing plate or under the outside thereof (i.e., as a film for lightweight provided with ITO). The antireflection mechanism of the touch sensitive panel includes a linear polarization type and a circular polarization type (the linear polarization type is of higher reflectance than the circular polarization type), and the optical film for protecting a polarizer of the present invention may be used in the circularly polarizing plate and a polarizing plate of the linearly polarization type.

The circularly polarizing plate or the linearly polarizing plate having the optical film for protecting a polarizer of the present invention used therein may be used in any of touch sensitive panels of a transmission type and a reflection type.

### EXAMPLE

The present invention is described in more detail with reference to example below, but the present invention is not limited to the examples.

### Evaluation Methods

### (1) Bending Elastic Modulus

A polypropylene resin is measured for bending elastic modulus according to JIS K7171.

### (2) Melt Flow Rate (MFR)

A polypropylene resin is measured for melt flow rate by using a melt indexer (“F-W01” (model number), produced by Toyo Seiki Seisaku-Sho, Ltd.) according to JIS K7210 under conditions of 230° C. and a load of 2.16 kg.

### (3) In-Plane Phase Retardation

An optical film is measured for in-plane phase retardation by using a phase difference measuring device (“KOBRA-WR” (model number), produced by Oji Scientific Instruments Co., Ltd.) under conditions of a wavelength of 589.3 nm and an incident angle of 0°, and evaluated by the following standard.

A: in-plane phase retardation of 0 nm or more and less than 20 nm
C: in-plane phase retardation of 20 nm or more

### (4) Haze (Turbidity)

An optical film is measured for haze according to JIS K7105, and evaluated by the following standard.

A: haze of less than 10%
C: haze of 10% or more

### (5) Visible Light Transmittance (Transparency)

An optical film is measured for light transmittance by using an ultraviolet and visible ray absorption analyzer (“UV-2400” (model number), produced by Shimadzu Corporation) under conditions of a wavelength of 550 nm and 750 nm, and evaluated by the following standard.

AA: light transmittance of from 90 to 100%
A: light transmittance of from 80 to 90%
C: light transmittance of less than 80%

### (6) Ultraviolet Ray Absorbing Capability

An optical film is measured for light transmittance by using an ultraviolet and visible ray absorption analyzer (“UV-2400” (model number), produced by Shimadzu Corporation) under conditions of a wavelength of 250 nm (UV-A region), 310 nm (UV-B region) and 330 nm and 370 nm (UV-C region), and the ultraviolet ray absorbing capability is evaluated by the following standard.

AA: light transmittance of 0% or more and less than 10%
A: light transmittance of 10% or more and less than 20%
B: light transmittance of 20% or more and less than 30%
C: light transmittance of 30% or more

### (7) Bleed Out of Ultraviolet Ray Absorbent

An optical film thus produced is allowed to stand under condition 1 of a temperature of 80° C. and uncontrolled humidity or condition 2 of a temperature of 60° C. and a relative humidity of 90% for 1,000 hours. The optical film thus allowed to stand is visually evaluated for appearance (i.e., the presence of bleed out of the ultraviolet ray absorbent) by the following standard.

A: no bleed out found
B: bleed out found, and partial whitening found, but no practical problem
C: bleed out found, and whitening found entirely

### Example 1

A propylene copolymer (“J-3021GR (trade name)”, produced by Prime Polymer Co., Ltd., a propylene copolymer produced with a Ziegler-Natta catalyst, bending elastic modulus: 1,000 MPa, melting point: 150° C., MFR: 33 g per 10 minutes, hereinafter referred to as “PP-A”) and 2-(2H-benzotriazol-2-yl)-4-(1,1,3,3-tetramethylbutyl)phenol (“TINUVIN 329 (trade name)”, produced by Ciba Specialty Chemicals Co., Ltd., hereinafter referred to as “UV-1”) were mixed to make a content of UV-1 in the mixture of 1.0% by mass with respect to the mixture, and the mixture was melted under heating. The mixture was extrusion-molded with a T-die under conditions of a processing temperature of 200° C. and a take-up roll temperature of 50° C. to a film having a thickness of 100 thereby providing an optical film for protecting a polarizer.

### Example 2

An optical film for protecting a polarizer was provided in the same manner as in Example 1 except that the content of UV-1 in the mixture was changed to 0.03% by mass with respect to the mixture.

### Example 3

An optical film for protecting a polarizer was provided in the same manner as in Example 1 except that the content of UV-1 in the mixture was changed to 0.1% by mass with respect to the mixture.

### Example 4

An optical film for protecting a polarizer was provided in the same manner as in Example 1 except that the content of UV-1 in the mixture was changed to 0.25% by mass with respect to the mixture.

### Example 5

An optical film for protecting a polarizer was provided in the same manner as in Example 1 except that the content of UV-1 in the mixture was changed to 0.5% by mass with respect to the mixture.

### Example 6

An optical film for protecting a polarizer was provided in the same manner as in Example 1 except that the content of UV-1 in the mixture was changed to 5% by mass with respect to the mixture.

### Example 7

An optical film for protecting a polarizer was provided in the same manner as in Example 1 except that the content of UV-1 in the mixture was changed to 6% by mass with respect to the mixture.

### Example 8

An optical film for protecting a polarizer was provided in the same manner as in Example 1 except that a sorbitol additive (1,3-2,4-di-p-methyldibenzylidene sorbitol, “IRGACLEAR DM (trade name), produced by Ciba Specialty Chemicals Co., Ltd.) was mixed with PP-A and UV-1 in such a ratio that provided a content of the sorbitol additive in the mixture of 0.1% by mass with respect to the mixture.

### Example 9

An optical film for protecting a polarizer was provided in the same manner as in Example 1 except that a propylene copolymer (“J-2041GA (trade name)”, produced by Prime Polymer Co., Ltd., a propylene copolymer produced with a Ziegler-Natta catalyst, bending elastic modulus: 850 MPa, melting point: 140° C., MFR: 22 g per 10 minutes, hereinafter referred to as “PP-B”) was used instead of PP-A.

### Example 10

An optical film for protecting a polarizer was provided in the same manner as in Example 1 except that a propylene copolymer (“J-2021GR (trade name)”, produced by Prime Polymer Co., Ltd., a propylene copolymer produced with a Ziegler-Natta catalyst, bending elastic modulus: 950 MPa, melting point: 150° C., MFR: 22 g per 10 minutes, hereinafter referred to as “PP-C”) was used instead of PP-A.

### Example 11

An optical film for protecting a polarizer was provided in the same manner as in Example 1 except that a propylene copolymer (“F-724NP (trade name)”, produced by Prime Polymer Co., Ltd., a propylene copolymer produced with a Ziegler-Natta catalyst, bending elastic modulus: 1,000 MPa, melting point: 146° C., MFR: 7 g per 10 minutes, hereinafter referred to as “PP-D”) was used instead of PP-A.

### Example 12

An optical film for protecting a polarizer was provided in the same manner as in Example 1 except that a propylene copolymer (“F-327 (trade name)”, produced by Prime Polymer Co., Ltd., a propylene copolymer produced with a Ziegler-Natta catalyst, bending elastic modulus: 780 MPa, melting point: 138° C., MFR: 7 g per 10 minutes, hereinafter referred to as “PP-E”) was used instead of PP-A.

### Comparative Example 1

An optical film for protecting a polarizer was provided in the same manner as in Example 1 except that UV-1 was not used.

### Comparative Example 2

An optical film for protecting a polarizer was provided in the same manner as in Example 1 except that 2-(2-hydroxy-5-methylphenyl)benzotriazole (“TINUVIN P (trade name), produced by Ciba Specialty Chemicals Co., Ltd., hereinafter referred to as “UV-2”) was used instead of UV-1.

### Comparative Example 3

An optical film for protecting a polarizer was provided in the same manner as in Example 1 except that a propylene resin (“J-2003GP (trade name)”, produced by Prime Polymer Co., Ltd., homopolypropylene produced with a Ziegler-Natta catalyst, bending elastic modulus: 1,900 MPa, melting point: 160° C., MFR: 21 g per 10 minutes, hereinafter referred to as “PP-F”) was used instead of PP-A.

### Comparative Example 4

An optical film for protecting a polarizer was provided in the same manner as in Example 1 except that a propylene resin (“Novatec FW4BT (trade name)”, produced by Japan Polypropylene Corporation, a propylene copolymer produced with a Ziegler-Natta catalyst, bending elastic modulus: 850 MPa, melting point: 140° C., MFR: 6.5 g per 10 minutes, hereinafter referred to as “PP-G”) was used instead of PP-A, and UV-1 was not mixed.

### Comparative Example 5

An optical film for protecting a polarizer was provided in the same manner as in Example 1 except that 2-(5-chloro-(2H)-benzotriazol-2-yl)-4-methyl-6-(tert-butyl)phenol (“TINUVIN 326FL (trade name), produced by Ciba Specialty Chemicals Co., Ltd., hereinafter referred to as “UV-3”) was used instead of UV-1.

### Comparative Example 6

An optical film for protecting a polarizer was provided in the same manner as in Example 1 except that 2,2′-methylenebis(6-(2H-benzotriazol-2-yl)-4-(1,1,3,3-tetramethylbutyl)phenol) (“TINUVIN 360 (trade name), produced by Ciba Specialty Chemicals Co., Ltd., hereinafter referred to as “UV-4”) was used instead of UV-1.

The evaluation results of the optical films for protecting a polarizer obtained in Examples 1 to 12 and Comparative Examples 1 to 6 are shown in Tables 1 and 2.

In Examples 1 to 12, in-plane phase retardation, haze and visible light transmittance of the optical films for protecting a polarizer containing the mixtures containing the polypropylene resin using the propylene copolymer (PP-A to PP-F) and 2-(2H-benzotriazol-2-yl)-4-(1,1,3,3-tetramethylbutyl)phenol (UV-1) were evaluations that were equivalent to the optical film for protecting a polarizer that did not contain UV-1 in Comparative Example 1. That is, UV-1 did not impair the favorable haze and visible light transmittance of the polypropylene resin using the propylene copolymer.

When 2-(2-hydroxy-5-methylphenyl)benzotriazole (UV-2) was used in Comparative Example 2, on the other hand, the haze was deteriorated, and fluctuation in haze occurred within the film plane. Furthermore, fluctuation in in-plane phase retardation and whitening due to bleed out of the ultraviolet ray absorbent were found. When the polypropylene resin using only the homopolypropylene (PP-F) was used in Comparative Example 3, the haze value was largely increased, and deterioration of the in-plane phase retardation was found.

It was apparent from the results of Comparative Examples 5 and 6 that when 2-(5-chloro-H)-benzotriazol-2-yl)-4-methyl-6-(tert-butyl)phenol (UV-3) and 2,2′-methylenebis(6-(2H-benzotriazol-2-yl)-4-(1,1,3,3-tetramethylbutyl)phenol) (UV-4) were used, the haze was deteriorated, and fluctuation in haze occurred within the film plane. Furthermore, fluctuation in in-plane phase retardation and whitening due to bleed out of the ultraviolet ray absorbent were found.

TABLE 1

| | | | | | | MFR | In-plane | | | |
|---|---|---|---|---|---|---|---|---|---|---|
| | | Ultraviolet ray | | Content of | Bending | (g per | phase | | | |
| | | absorbent | | sorbitol | elastic | 10 | retardation | | Haze | |
| | PP | Kind | Content (%) | additive (%) | modulus (MPa) | minutes) | (nm) | | (%) | |
| Example 1 | PP-A | UV-1 | 1.0 | — | 1,000 | 33 | 8 | A | 3 | A |
| Example 2 | PP-A | UV-1 | 0.03 | — | 1,000 | 33 | 8 | A | 3 | A |
| Example 3 | PP-A | UV-1 | 0.1 | — | 1,000 | 33 | 7 | A | 2 | A |
| Example 4 | PP-A | UV-1 | 0.25 | — | 1,000 | 33 | 7 | A | 3 | A |
| Example 5 | PP-A | UV-1 | 0.5 | — | 1,000 | 33 | 7 | A | 3 | A |
| Example 6 | PP-A | UV-1 | 5.0 | — | 1,000 | 33 | 7 | A | 4 | A |
| Example 7 | PP-A | UV-1 | 6.0 | — | 1,000 | 33 | 9 | A | 3 | A |
| Example 8 | PP-A | UV-1 | 1.0 | 0.1 | 1,000 | 33 | 8 | A | 3 | A |
| Example 9 | PP-B | UV-1 | 1.0 | — | 850 | 22 | 10 | A | 2 | A |
| Example 10 | PP-C | UV-1 | 1.0 | — | 950 | 22 | 13 | A | 2 | A |
| Example 11 | PP-D | UV-1 | 1.0 | — | 1,000 | 7 | 14 | A | 3 | A |
| Example 12 | PP-E | UV-1 | 1.0 | — | 780 | 7 | 7 | A | 5 | A |
| Comparative | PP-A | — | — | — | 1,000 | 33 | 7 | A | 3 | A |
| Example 1 | | | | | | | | | | |
| Comparative | PP-A | UV-2 | 1.0 | — | 1,000 | 33 | 6-21 | C | 6-12 | C |
| Example 2 | | | | | | | | | | |
| Comparative | PP-F | UV-1 | 1.0 | — | 1,900 | 21 | 42 | C | 20 | C |
| Example 3 | | | | | | | | | | |
| Comparative | PP-G | — | — | — | 850 | 6.5 | 21 | C | 5 | A |
| Example 4 | | | | | | | | | | |
| Comparative | PP-A | UV-3 | 1.0 | — | 1,000 | 33 | 6-26 | C | 4-19 | C |
| Example 5 | | | | | | | | | | |
| Comparative | PP-A | UV-4 | 1.0 | — | 1,000 | 33 | 6-22 | C | 3-12 | C |
| Example 6 | | | | | | | | | | |

TABLE 2

| | Visible light | | Ultraviolet ray absorbing capability | | | | | |
|---|---|---|---|---|---|---|---|---|
| | transmittance | | UV-A | UV-B | UV-C | UV-D | Evaluation of | |
| | 550 nm | 750 nm | 250 nm | 310 nm | 330 nm | 370 nm | bleed out | |
| | (%) | (%) | (%) | (%) | (%) | (%) | Condition | Condition |
| | evaluation | evaluation | evaluation | evaluation | evaluation | evaluation | 1 | 2 |
| Example 1 | 91.2 | 91.5 | 0.9 | 0.1 | 2.2 | 1.0 | A | A |
| | AA | AA | AA | AA | AA | AA | | |
| Example 2 | 90.8 | 92.0 | 34.0 | 19.5 | 20.4 | 33.8 | A | A |
| | AA | AA | C | A | B | C | | |
| Example 3 | 91.9 | 90.5 | 30.5 | 18.4 | 16.3 | 29.9 | A | A |
| | AA | AA | B | A | A | B | | |
| Example 4 | 91.1 | 92.8 | 27.0 | 14.2 | 15.5 | 23.8 | A | A |
| | AA | AA | B | A | A | B | | |
| Example 5 | 91.4 | 92.0 | 8.9 | 2.5 | 1.9 | 9.5 | A | A |
| | AA | AA | AA | AA | AA | AA | | |
| Example 6 | 90.6 | 91.0 | 0.9 | 0.4 | 0.3 | 0.8 | B | B |
| | AA | AA | AA | AA | AA | AA | | |
| Example 7 | 91.7 | 91.8 | 0.8 | 0.1 | 0.1 | 0.8 | C | C |
| | AA | AA | AA | AA | AA | AA | | |
| Example 8 | 91.3 | 91.5 | 0.8 | 0.2 | 0.2 | 1.0 | A | A |
| | AA | AA | AA | AA | AA | AA | | |
| Example 9 | 92.0 | 92.7 | 2.1 | 0.2 | 0.2 | 1.5 | A | A |
| | AA | AA | AA | AA | AA | AA | | |
| Example 10 | 91.2 | 91.5 | 0.9 | 0.1 | 2.2 | 1.0 | A | A |
| | AA | AA | AA | AA | AA | AA | | |
| Example 11 | 91.2 | 91.5 | 0.9 | 0.1 | 2.2 | 1.0 | A | A |
| | AA | AA | AA | AA | AA | AA | | |
| Example 12 | 91.2 | 91.5 | 0.9 | 0.1 | 2.2 | 1.0 | A | A |
| | AA | AA | AA | AA | AA | AA | | |
| Comparative | 91.2 | 91.8 | 86.9 | 89.38 | 89.14 | 90.4 | A | A |
| Example 1 | AA | AA | C | C | C | C | | |
| Comparative | 91.2 | 91.7 | 0.3 | 0.1 | 0.1 | 0.3 | C | C |
| Example 2 | AA | AA | AA | AA | AA | AA | | |
| Comparative | 91.9 | 92.0 | 12.8 | 1.4 | 1.9 | 2.1 | A | A |
| Example 3 | AA | AA | A | AA | AA | AA | | |
| Comparative | 91.0 | 90.2 | 86.3 | 89.8 | 90.3 | 90.5 | A | A |
| Example 4 | AA | AA | C | C | C | C | | |
| Comparative | 92.0 | 93.1 | 1.2 | 0.1 | 0.1 | 0.1 | C | C |
| Example 5 | AA | AA | AA | AA | AA | AA | | |
| Comparative | 92.3 | 93.3 | 2.3 | 0.1 | 0.1 | 0.2 | C | C |
| Example 6 | AA | AA | AA | AA | AA | AA | | |

### INDUSTRIAL APPLICABILITY

According to the present invention, such an optical film for protecting a polarizer is provided that has an ultraviolet ray absorbing function and is excellent in optical characteristics, such as transparency, turbidity (haze) and in-plane phase retardation. The protective film causes no bleed out of an ultraviolet ray upon molding the film.

The use of the optical film for protecting a polarizer of the present invention provides a polarizing plate and an image display apparatus that have high performance.

1. An optical film for protecting a polarizer, comprising a mixture containing a polypropylene resin containing a propylene copolymer, and 2-(2H-benzotriazol-2-yl)-4-(1,1,3,3-tetramethylbutyl)phenol.

2. The optical film for protecting a polarizer according to claim 1, wherein a content of 2-(2H-benzotriazol-2-yl)-4-(1,1,3,3-tetramethylbutyl)phenol in the mixture is from 0.08 to 5.5% by mass.

3. The optical film for protecting a polarizer according to claim 1, wherein the polypropylene resin has a melt flow rate of 7 g per 10 minutes or more.

4. A polarizing plate comprising a polarizer having formed on at least one surface thereof the optical film for protecting a polarizer according to claim 1.

5. An image display apparatus comprising the polarizing plate according to claim 4.
